(19) United States
(12) Patent Application Publication
(10) Pub. No.: US 2017/0219899 A1
(43) Pub. Date: Aug. 3, 2017

(54) ACTIVE MATRIX SUBSTRATE, LIQUID CRYSTAL PANEL, AND METHOD FOR MANUFACTURING ACTIVE MATRIX SUBSTRATE

(71) Applicant: Sharp Kabushiki Kaisha, Sakai City, Osaka (JP)

(72) Inventors: Tomoo FURUKAWA, Sakai City (JP); Junichi MORINAGA, Sakai City (JP); Masakatsu TOMINAGA, Sakai City (JP); Hidenobu KIMOTO, Sakai City (JP); Yoshihiro SEGUCHI, Sakai City (JP)

(21) Appl. No.: 15/500,569

(22) PCT Filed: Jun. 24, 2015
(86) PCT No.: PCT/JP2015/068177

§ 371 Date: Jan. 31, 2017

(30) Foreign Application Priority Data
Aug. 7, 2014 (JP) 2014-161941

(51) Int. Cl. G02F 1/1362; G02F 1/1343; G02F 1/1335; G02F 1/1339; G02F 1/1368; G02F 1/1333

(52) U.S. Cl. CPC G02F 1/136286; G02F 1/1368; G02F 1/133345; G02F 1/133512; G02F 1/13394; G02F 1/134363; G02F 1/13439; G02F 2201/123; G02F 2201/121; G02F 1/13306

(57) ABSTRACT

An active matrix substrate for a liquid crystal panel of an FFS mode includes gate lines, data lines, pixel circuits each including a switching element and a pixel electrode, a protective insulating film formed in a layer over these elements, and a common electrode 30 formed in a layer over the protective insulating film. The common electrode 30 has slits 31 corresponding to the pixel electrode, for generating a lateral electric field to be applied to a liquid crystal layer. In the common electrode 30, a cutout above data line 32 having a portion extending in the same direction as that of the data line is formed in a region including a part of a placement region for the data line. On a counter substrate, a black matrix is formed in a position that faces a region including placement regions for the gate line, the data line, the switching element, and the cutout above data line 32. This reduces display failure caused by a load of the data line.

### TECHNICAL FIELD

The present invention relates to a display device, and particularly relates to an active matrix substrate having a common electrode, a liquid crystal panel including the active matrix substrate, and a method for manufacturing the active matrix substrate having the common electrode.

### BACKGROUND ART

A liquid crystal display device has been widely used as a thin, light-weight, and low power consumption display device. A liquid crystal panel included in the liquid crystal display device has a structure formed by attaching an active matrix substrate and a counter substrate together, and providing a liquid crystal layer between the two substrates. A plurality of gate lines, a plurality of data lines, and a plurality of pixel circuits each including a thin film transistor (hereinafter referred to as TFT) and a pixel electrode are formed on the active matrix substrate.

As a system for applying an electric field to the liquid crystal layer of the liquid crystal panel, a vertical electric field system and a lateral electric field system are known. In a liquid crystal panel of the vertical electric field system, an almost vertical electric field is applied to the liquid crystal layer by using the pixel electrode and a common electrode formed on the counter substrate. In a liquid crystal panel of the lateral electric field system, the common electrode is formed on the active matrix substrate together with the pixel electrode, and an almost lateral electric field is applied to the liquid crystal layer by using the pixel electrode and the common electrode. The liquid crystal panel of the lateral electric field system has an advantage of having a wider view angle than that in the liquid crystal panel of the vertical electric field system.

As the lateral electric field system, an IPS (In-Plane Switching) mode and an FFS (Fringe Field Switching) mode are known. In a liquid crystal panel of the IPS mode, the pixel electrode and the common electrode are each formed in the shape of comb teeth, and are disposed so as not to overlap each other in a plan view. In a liquid crystal panel of the FFS mode, a slit is formed either in the common electrode or the pixel electrode, and the pixel electrode and the common electrode are disposed so as to overlap each other via a protective insulating film in a plan view. The liquid crystal panel of the FFS mode has an advantage of having a higher aperture ratio than that in the liquid crystal panel of the IPS mode.

Further, the liquid crystal panels are classified into those having vertically long pixels and those having horizontally long pixels. In the liquid crystal display device that displays color images by using N colors, one color pixel is made up of N pixels (also called sub-pixels). For example, in a liquid crystal display device that displays color images by using red, green, and blue, one color pixel is made up of three pixels which are red, green, and blue pixels. In a large number of conventional liquid crystal panels, as shown in FIG. 14, the color pixel is divided into N (N=3, here) vertically long pixels. Further, as shown in FIG. 15, there has also been used a liquid crystal panel where the color pixel is divided into N horizontally long pixels.

In the liquid crystal panel having horizontally long pixels, the number of gate lines is N times as large, and the number of data lines is one N-th as large, as compared with the liquid crystal panel having vertically long pixels. Generally, a data line drive circuit has a more complex configuration and higher manufacturing cost than those in a gate line drive circuit. For this reason, using a liquid crystal panel having horizontally long pixels can reduce the cost of the drive circuit more than in the case of using the liquid crystal panel having vertically long pixels.

Further, a technique of forming the gate line drive circuit integrally with the pixel circuit on the active matrix substrate (which is called a gate drive monolithic technique) has been widely put to practical use. By using the gate drive monolithic technique, even when the number of gate lines increases due to the use of horizontally long pixels, it is possible to reduce a rise in cost of the gate line drive circuit which is accompanied by the increase in number of gate lines. In the meantime, by reducing the number of data lines, it is possible to reduce a circuit amount of the data line drive circuit that is hard to be formed on the active matrix substrate, and reduce the cost of the liquid crystal display device.

For example, Patent Document 1 describes a liquid crystal panel of the FFS mode which has horizontally long pixels. Patent Document 1 describes that a common electrode having a variety of shapes is provided in a layer over a gate line, a data line, a TFT, and a pixel electrode.

### PRIOR ART DOCUMENT

### Patent Document

[Patent Document 1] Japanese Laid-Open Patent Publication No. 2013-182127

### SUMMARY OF THE INVENTION

### Problems to be Solved by the Invention

In the liquid crystal panel having horizontally long pixels, the number of times one data line intersects with the gate lines is large and a load (capacitance) of the data line is large as compared with those in the liquid crystal panel having vertically long pixels. When the load of the data line is large, a consumption current increases. Further, when the load of the data line is large, rounding of a signal inputted into the data line increases, which may disable a correct writing of a voltage into the pixel circuit within a predetermined time. On this account, the liquid crystal panel having horizontally long pixels has a problem in that display failure such as a luminance decrease and luminance unevenness occurs easily.

Patent Document 1 describes a method of using an organic film for a protective insulating film so as to reduce the load of the data line. However, this method has a problem of increasing manufacturing cost and reducing transmittance. The display failure caused by the load of the data line easily occurs in the liquid crystal panel of the FFS mode which has horizontally long pixels. However, in addition to the above case, the display failure also occurs in the liquid crystal panel having vertically long pixels and in the liquid crystal panel of the vertical electric field system.

Accordingly, an object of the present invention is to provide an active matrix substrate that reduces display failure caused by a load of a data line, and provide a liquid crystal panel including the active matrix substrate.

### Means for Solving the Problems

According to a first aspect of the present invention, there is provided an active matrix substrate including: a plurality of gate lines extending in a first direction; a plurality of data lines extending in a second direction; a plurality of pixel circuits arranged corresponding to intersections of the gate lines and the data lines and each including a switching element and a pixel electrode; a protective insulating film formed in a layer over the gate line, the data line, the switching element, and the pixel electrode; and a common electrode formed in a layer over the protective insulating film, wherein the common electrode has a cutout above the data line, the cutout above the data line being formed in a region including a part of a placement region for the data line and having a portion extending in the second direction.

According to a second aspect of the present invention, in the first aspect of the present invention, the common electrode further has a cutout above the switching element, the cutout above the switching element being formed in a region including a placement region for a data-line-side electrode and a channel region of the switching element.

According to a third aspect of the present invention, in the second aspect of the present invention, the cutout above the data line and the cutout above the switching element are formed integrally.

According to a fourth aspect of the present invention, in the third aspect of the present invention, the cutout above the data line and the cutout above the switching element are formed corresponding to each pixel circuit.

According to a fifth aspect of the present invention, in the third aspect of the present invention, the cutout above the data line and the cutout above the switching element are formed corresponding to a plurality of pixel circuits that are adjacent in the second direction.

According to a sixth aspect of the present invention, in the first aspect of the present invention, the data line is a wiring formed by laminating a plurality of materials, and a first material included in the plurality of materials is the same as a material for the pixel electrode.

According to a seventh aspect of the present invention, in the sixth aspect of the present invention, the switching element includes a semiconductor layer, and a second material included in the plurality of materials is the same as the material for the semiconductor layer.

According to an eighth aspect of the present invention, in the first aspect of the present invention, the common electrode has a plurality of slits extending in the first direction, corresponding to the pixel electrode.

According to a ninth aspect of the present invention, in the first aspect of the present invention, a length of the pixel circuit in the first direction is longer than a length of the pixel circuit in the second direction.

According to a tenth aspect of the present invention, in the first aspect of the present invention, the switching element includes a control electrode connected to the gate line, a first conductive electrode connected to the data line, and a second conductive electrode connected to the pixel electrode.

According to an eleventh aspect of the present invention, there is provided a liquid crystal panel including: an active matrix substrate; and a counter substrate that is disposed facing the active matrix substrate and has a black matrix, wherein the active matrix substrate includes: a plurality of gate lines extending in a first direction; a plurality of data lines extending in a second direction; a plurality of pixel circuits arranged corresponding to intersections of the gate lines and the data lines and each including a switching element and a pixel electrode; a protective insulating film formed in a layer over the gate line, the data line, the switching element, and the pixel electrode; and a common electrode formed in a layer over the protective insulating film, the common electrode has a cutout above the data line, the cutout above the data line being formed in a region including a part of a placement region for the data line and having a portion extending in the second direction, and the black matrix is formed in a position that faces a region including placement regions for the gate line, the data line, the switching element, and the cutout above the data line.

According to a twelfth aspect of the present invention, in the eleventh aspect of the present invention, the counter substrate has a columnar spacer in a position corresponding to the cutout above the data line.

According to a thirteenth aspect of the present invention, there is provided a method for manufacturing an active matrix substrate, the method including the steps of: forming a plurality of gate lines extending in a first direction, a plurality of data lines extending in a second direction, and a plurality of pixel circuits arranged corresponding to intersections of the gate lines and the data lines and each including a switching element and a pixel electrode; forming a protective insulating film formed in a layer over the gate line, the data line, the switching element, and the pixel electrode; and forming, in a layer over the protective insulating film, a common electrode having a cutout above the data line, the cutout above the data line being formed in a region including a part of a placement region for the data line and having a portion extending in the second direction, and a slit for generating a lateral electric field.

According to a fourteenth aspect of the present invention, in the thirteenth aspect of the present invention, the data line is a wiring formed by laminating a plurality of materials including a first material, and the step of forming the gate line, the data line, and the pixel circuit includes a step of forming, together with the pixel electrode, a layer of the data line, the layer being formed of the first material.

According to a fifteenth aspect of the present invention, in the fourteenth aspect of the present invention, the switching element includes a semiconductor layer, the plurality of materials include a second material, and the step of forming the gate line, the data line, and the pixel circuit includes a step of forming, together with the semiconductor layer, a layer of the data line, the layer being formed of the second material.

### Effects of the Invention

According to the first aspect of the present invention, forming the cutout above the data line in the common electrode can reduce parasitic capacitance that is generated between the data line and the common electrode, and reduce a load (capacitance) of the data line. It is thus possible to prevent display failure such as a luminance decrease and luminance unevenness caused by the load of the data line.

According to the second aspect of the present invention, forming the cutout above the switching element in the common electrode can reduce parasitic capacitance that is generated between the common electrode and the data-line-side electrode/the channel region of the switching element, and further reduce the load of the data line.

According to the third aspect of the present invention, integrally forming the two kinds of cutouts can reduce the load of the data line more than the case of separately forming the two kinds of cutouts.

According to the fourth aspect of the present invention, forming the cutout corresponding to each pixel circuit can reduce in-plane variation in resistance of the common electrode, and make the voltage of the common electrode constant without depending on its location.

According to the fifth aspect of the present invention, forming the cutout corresponding to the plurality of pixel circuits can further reduce the load of the data line.

According to the sixth aspect of the present invention, the use of the data line, which has the layer formed of the same material as that for the pixel electrode, can reduce the resistance of the data line.

According to the seventh aspect of the present invention, the use of the data line, which has the layer formed of the same material as that for the semiconductor layer of the switching element, can further reduce the resistance of the data line.

According to the eighth aspect of the present invention, the plurality of slits extending in the first direction are formed in the common electrode to allow application of a lateral electric field to the liquid crystal layer by using the common electrode and the pixel electrode.

According to the ninth aspect of the present invention, even when the length of the pixel circuit in a direction in which the gate line extends is longer than that in a direction in which the data line extends, and the display failure caused by the load of the data line occurs easily, forming the cutout above the data line in the common electrode can reduce the load of the data line and prevent the display failure caused by the load of the data line.

According to the tenth aspect of the present invention, in the active matrix substrate where the switching element is connected to the gate line, the data line, and the pixel electrode, it is possible to prevent the display failure caused by the load of the data line.

According to the eleventh aspect of the present invention, the black matrix is formed on the counter substrate while facing the cutout above the data line, thus making it possible to hide an influence of alignment disorder due to provision of the cutout above the data line.

According to the twelfth aspect of the present invention, the columnar spacer is formed on the counter substrate while facing the cutout above the data line, to eliminate the need for disposing an excess portion of the black matrix for hiding an influence of alignment disorder due to the columnar spacer. Further, since the portion where the data line is formed is flatter than the portion where the switching element is formed, the constant interval between the active matrix substrate and the counter substrate can be held stably.

According to the thirteenth aspect of the present invention, the cutout above the data line is formed through the same process as that for the slit for generating the lateral electric field to prevent the display failure caused by the load of the data line, thereby allowing manufacturing of the active matrix substrate having the common electrode provided with the cutout above the data line, without increasing the number of processes.

According to the fourteenth aspect of the present invention, a layer of the data line is formed of the first material together with the pixel electrode, to allow manufacturing of the active matrix substrate with reduced resistance of the data line, without increasing the number of processes.

According to the fifteenth aspect of the present invention, another layer of the data line is formed of the second material, together with the semiconductor layer of the switching elements, to allow manufacturing of the active matrix substrate with further reduced resistance of the data line, without increasing the number of processes.

### BRIEF DESCRIPTION OF THE DRAWINGS

FIG. 1 is a block diagram showing a configuration of a liquid crystal display device provided with an active matrix substrate according to a first embodiment of the present invention.

FIG. 2 is a plan view of the active matrix substrate shown in FIG. 1.

FIG. 3 is a layout diagram of a liquid crystal panel shown in FIG. 1.

FIG. 4 is a diagram showing patterns other than a pattern of a common electrode of the active matrix substrate shown in FIG. 1.

FIG. 5 is a diagram showing the pattern of the common electrode of the active matrix substrate shown in FIG. 1.

FIG. 6 is a diagram showing a pattern of a counter substrate shown in FIG. 1.

FIG. 7A is a diagram showing a method for manufacturing the active matrix substrate shown in FIG. 1.

FIG. 7B is a diagram continued from FIG. 7A.

FIG. 7C is a diagram continued from FIG. 7B.

FIG. 7D is a diagram continued from FIG. 7C.

FIG. 7E is a diagram continued from FIG. 7D.

FIG. 7F is a diagram continued from FIG. 7E.

FIG. 7G is a diagram continued from FIG. 7F.

FIG. 7H is a diagram continued from FIG. 7G.

FIG. 7I is a diagram continued from FIG. 7H.

FIG. 8 is a sectional view of the liquid crystal panel shown in FIG. 1.

FIG. 9 is a layout diagram of an active matrix substrate according to a second embodiment of the present invention.

FIG. 10 is a diagram showing a pattern of a common electrode of the active matrix substrate shown in FIG. 9.

FIG. 11A is a diagram showing a method for manufacturing an active matrix substrate according to a third embodiment of the present invention.

FIG. 11B is a diagram continued from FIG. 11A.

FIG. 11C is a diagram continued from FIG. 11B.

FIG. 11D is a diagram continued from FIG. 11C.

FIG. 11E is a sectional view of elements formed in the active matrix substrate according to the third embodiment of the present invention.

FIG. 12 is a sectional view of a liquid crystal panel according to the third embodiment of the present invention.

FIG. 13 is a diagram showing a pattern of a common electrode of an active matrix substrate according to a fourth embodiment of the present invention.

FIG. 14 is a diagram showing vertically long pixels.

FIG. 15 is a diagram showing horizontally long pixels.

### MODES FOR CARRYING OUT THE INVENTION

### First Embodiment

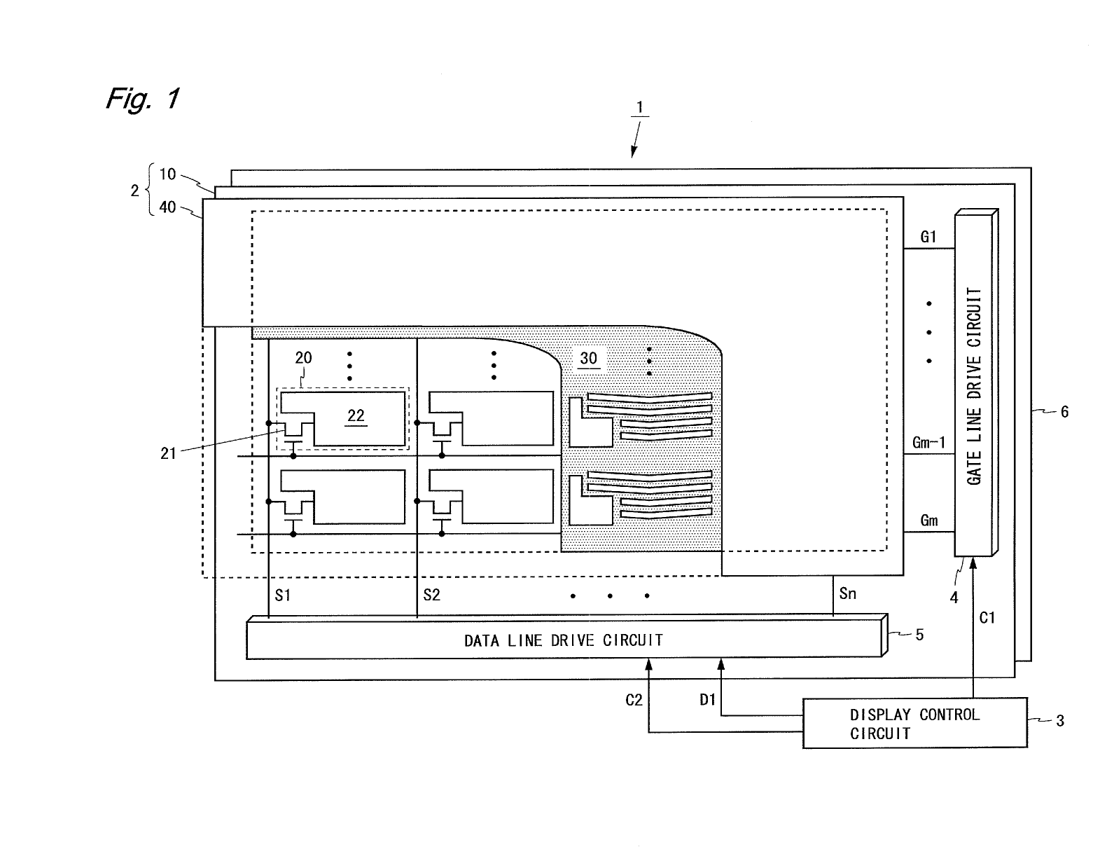

FIG. 1 is a block diagram showing a configuration of a liquid crystal display device provided with an active matrix substrate according to a first embodiment of the present invention. A liquid crystal display device 1 shown in FIG. 1 includes a liquid crystal panel 2, a display control circuit 3, a gate line drive circuit 4, a data line drive circuit 5, and a backlight 6. Hereinafter, m and n are integers not smaller than 2, i is an integer not smaller than 1 and not larger than m, and j is an integer not smaller than 1 and not larger than n.

The liquid crystal panel 2 is a liquid crystal panel of an FFS mode which has horizontally long pixels. The liquid crystal panel 2 has a structure formed by attaching an active matrix substrate 10 and a counter substrate 40 together, and providing a liquid crystal layer between the two substrates. A black matrix (not shown) and the like are formed on the counter substrate 40. m gate lines G1 to Gm, n data lines S1 to Sn, (m×n) pixel circuits 20, a common electrode 30 (dot pattern part), and the like are formed on the active matrix substrate 10. A semiconductor chip to function as the gate line drive circuit 4 and a semiconductor chip to function as the data line drive circuit 5 are mounted on the active matrix substrate 10. Note that FIG. 1 schematically shows the configuration of the liquid crystal display device 1, and shapes of the elements shown in FIG. 1 are not accurate.

Hereinafter, a direction in which the gate line extends (a horizontal direction in the drawing) is referred to as a row direction, and a direction in which the data line extends (a vertical direction in the drawing) is referred to as a column direction. The gate lines G1 to Gm extend in the row direction and are arranged in parallel with each other. The data lines S1 to Sn extend in the column direction and are arranged in parallel with each other. The gate lines G1 to Gm and the data lines S1 to Sn intersect at (m×n) points. The (m×n) pixel circuits 20 are arranged two-dimensionally corresponding to the intersections of the gate lines G1 to Gm and the data lines S1 to Sn. When the liquid crystal display device 1 displays color images by using N colors, the (m×n) pixel circuits 20 correspond to (m/N×n) color pixels in which (m/N) color pixels are aligned in the column direction and n color pixels are aligned in the row direction.

The pixel circuit 20 includes an N-channel TFT 21 and a pixel electrode 22. The TFT 21 included in the pixel circuit 20 in an i-th row and a j-th column has a gate electrode connected to a gate line Gi, a source electrode connected to a data line Sj, and a drain electrode connected to the pixel electrode 22. A protective insulating film (not shown) is formed in a layer over the gate lines G1 to Gm, the data lines S1 to Sn, the TFT 21, and the pixel electrode 22. The common electrode 30 is formed in a layer over the protective insulating film. The pixel electrode 22 and the common electrode 30 face each other with the protective insulating film interposed therebetween. The backlight 6 is disposed on the back surface side of the liquid crystal panel 2 and irradiates the back surface of the liquid crystal panel 2 with light.

The display control circuit 3 outputs a control signal C1 to the gate line drive circuit 4, and outputs a control signal C2 and a data signal D1 to the data line drive circuit 5. The gate line drive circuit 4 drives the gate lines G1 to Gm based on the control signal C1. The data line drive circuit 5 drives the data lines S1 to Sn based on the control signal C2 and the data signal D1. More specifically, the gate line drive circuit 4 selects one gate line from among the gate lines G1 to Gm in each horizontal period (line period), and applies a high-level voltage to the selected gate line. The data line drive circuit 5 respectively applies n data voltages in accordance with the data signal D1 to the data lines S1 to Sn in each horizontal period. Hence, n pixel circuits 20 are selected within one horizontal period, and n data voltages are respectively written to the selected n pixel circuits 20.

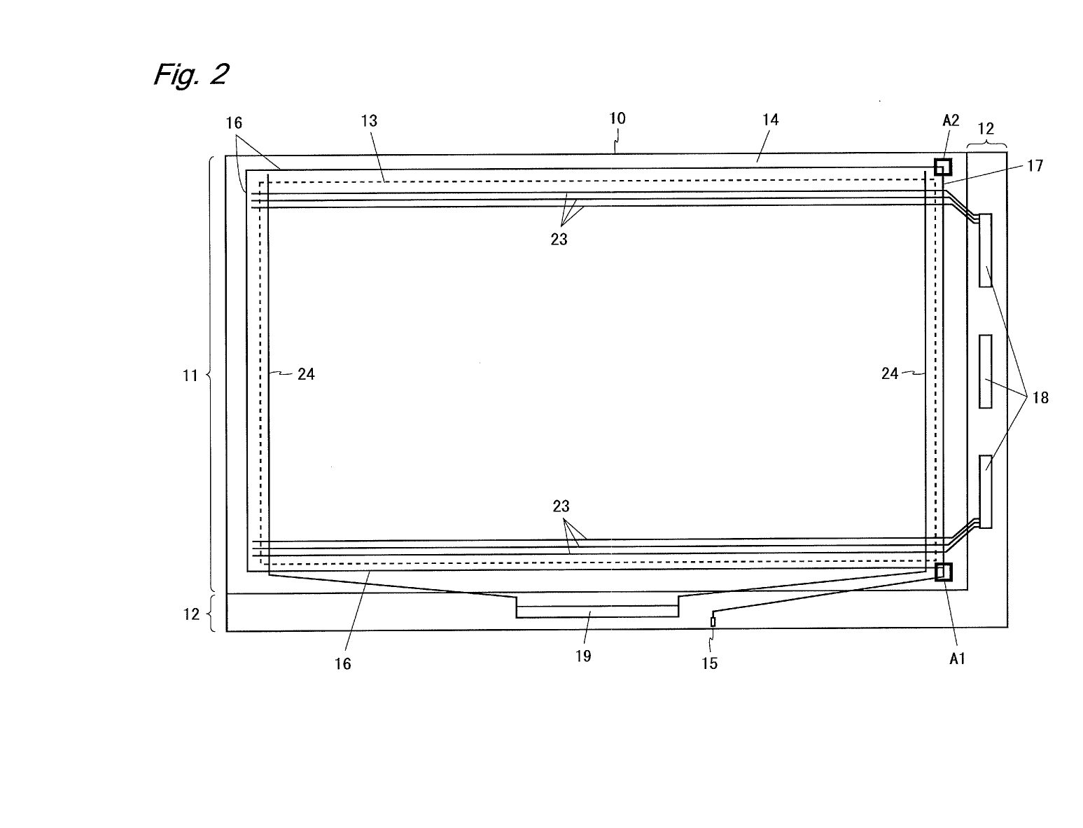

FIG. 2 is a plan view of the active matrix substrate 10. Part of elements formed on the active matrix substrate 10 is shown in FIG. 2. As shown in FIG. 2, the active matrix substrate 10 is divided into a counter region 11 facing the counter substrate 40, and a non-counter region 12 not facing the counter substrate 40. In FIG. 2, the non-counter region 12 is located in the right side and the lower side of the counter region 11. A display region 13 (a region indicated by a broken line) for disposing the pixel circuits 20 is set in the counter region 11. A portion remaining after removing the display region 13 from the counter region 11 is referred to as a picture-frame region 14.

The (m×n) pixel circuits 20, the m gate lines 23, and the n data lines 24 are formed in the display region 13. The (m×n) pixel circuits 20 are arranged two-dimensionally in the display region 13. An external terminal 15 for inputting a common electrode signal is provided to the non-counter region 12. For applying, to the common electrode 30, the common electrode signal inputted through the external terminal 15, a first common main wiring 16 formed in the same wiring layer as the gate line 23 and a second common main wiring 17 formed in the same wiring layer as the data line 24 are formed in the picture-frame region 14. In FIG. 2, the first common main wiring 16 is formed in the left side, the upper side, and the lower side of the display region 13, and the second common main wiring 17 is formed in the right side of the display region 13. Further, a connecting circuit (not shown) for connecting the common electrode 30, the first common main wiring 16, and the second common main wiring 17 is formed in each of an A1 part and an A2 part of FIG. 2. A mounting region 18 for mounting the gate line drive circuit 4 and a mounting region 19 for mounting the data line drive circuit 5 are set in the non-counter region 12.

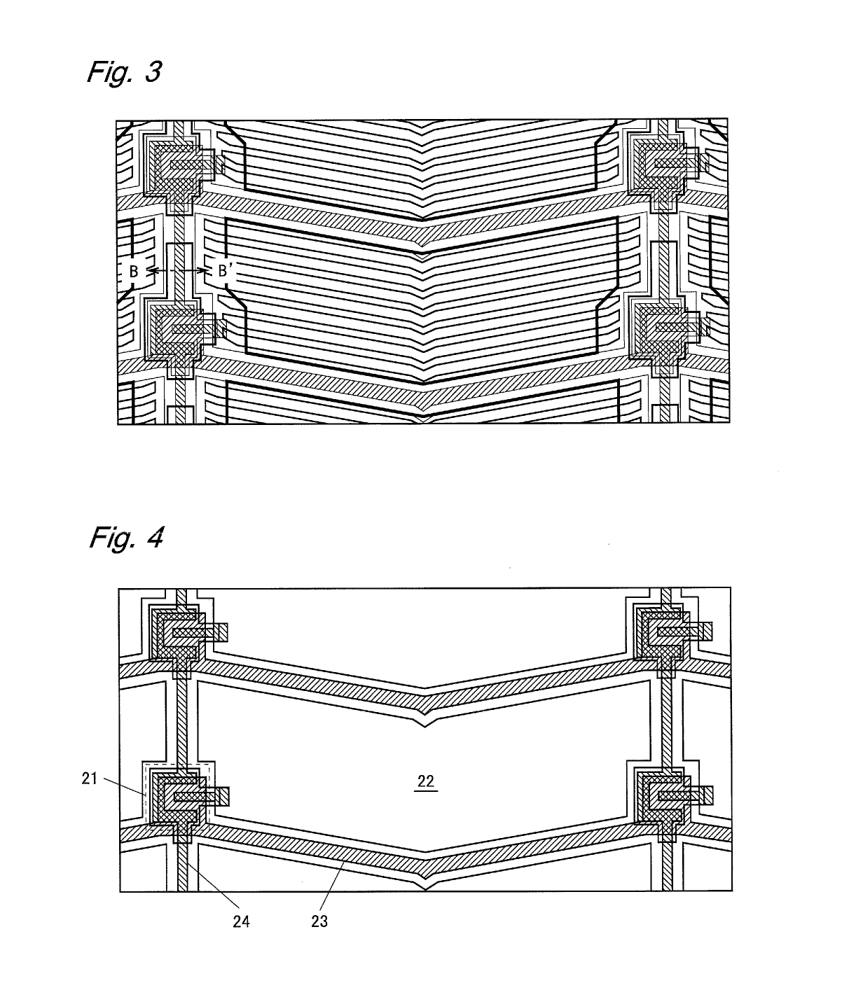

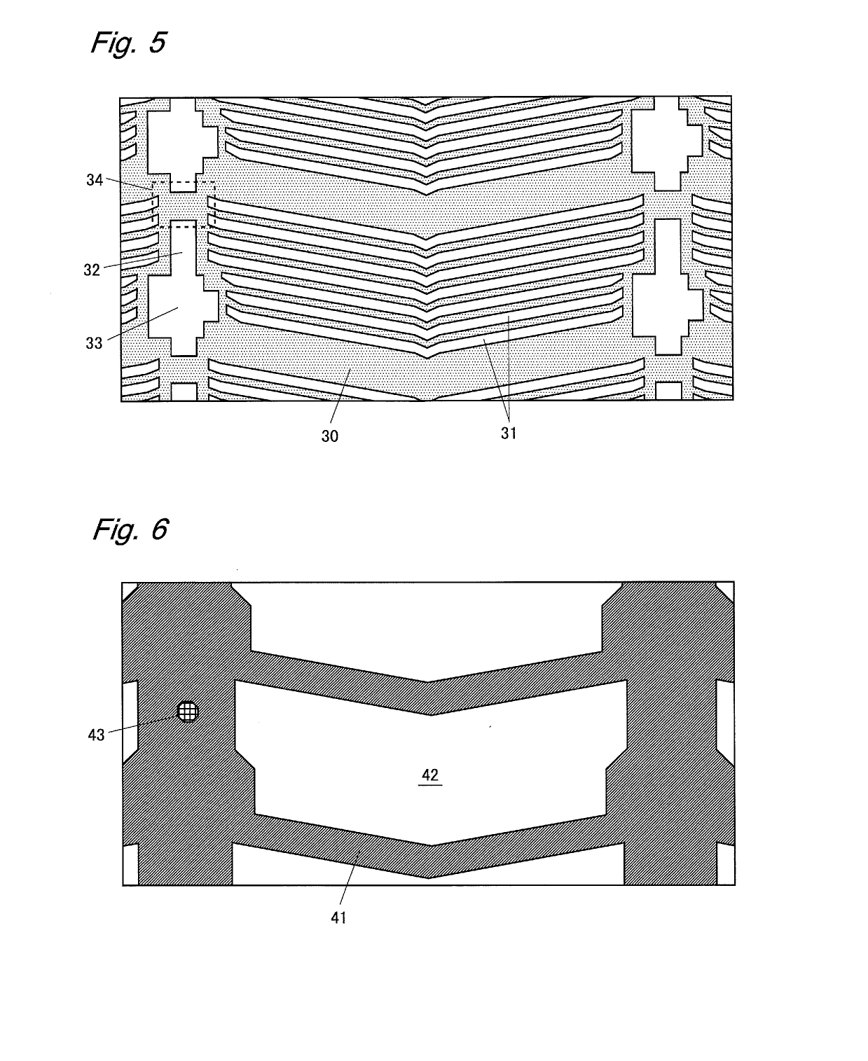

FIG. 3 is a layout diagram of the liquid crystal panel 2. FIG. 3 shows a pattern of the active matrix substrate 10 and a pattern of the counter substrate 40 in an overlapping manner. FIG. 3 is described by dividing the figure into three figures. FIG. 4 is a diagram showing patterns other than a pattern of the common electrode 30 of the active matrix substrate 10. FIG. 5 is a diagram showing the pattern of the common electrode 30 of the active matrix substrate 10. FIG. 6 is a diagram showing the pattern of the counter substrate 40. For facilitating understanding of the drawings, in FIG. 3, the patterns shown in FIG. 4 are indicated by thin lines, the pattern shown in FIG. 5 is indicated by thick lines, and the pattern shown in FIG. 6 is indicated by medium thick lines.

As shown in FIG. 4, the gate line 23 (left down oblique line part) extends in the row direction while bending in the middle. The data line 24 (right down oblique line part) extends in the column direction while bending in the vicinity of an intersection with the gate line 23. The gate line 23 and the data line 24 are formed in different wiring layers. The TFT 21 is formed in the vicinity of the intersection of the gate line 23 and the data line 24. The pixel electrode 22 is formed in a region separated by the gate lines 23 and the data lines 24. The TFT 21 has a gate electrode connected to the gate line 23, a source electrode connected to the data line 24, and a drain electrode connected to the pixel electrode 22. The length of the pixel electrode 22 in the row direction is longer than the length of the pixel electrode 22 in the column direction. In such a manner, the liquid crystal panel 2 is provided with a plurality of pixel circuits 20 arranged corresponding to intersections of the gate lines 23 and the data lines 24. The length of the pixel circuit 20 in the row direction is longer than the length of the pixel circuit 20 in the column direction.

The common electrode 30 is formed in a layer over the protective insulating film which is formed in a layer over the TFT 21, the pixel electrode 22, the gate line 23, and the data line 24 (i.e., closer side to the liquid crystal layer). As shown in FIG. 5, the common electrode 30 is formed so as to cover the whole surface of the display region 13 except for the following portions. The common electrode 30 has a plurality of slits 31 corresponding to the pixel electrode 22 so as to generate, together with the pixel electrode 22, a lateral electric field to be applied to the liquid crystal layer. In FIG. 5, the common electrode 30 has seven slits 31 corresponding to one pixel electrode 22. The length of the slit 31 in the row direction is longer than that in the column direction. The slit 31 bends around its middle. It is possible to widen a view angle of the liquid crystal panel 2 by forming the bent slits 31 in the common electrode 30.

The common electrode 30 has a cutout 32 that is formed in a region including a part of a placement region for the data line 24 and has a portion extending in the column direction. Further, the common electrode 30 has a cutout 33 that is formed in a region including a placement region for the source electrode and a channel region of the TFT 21. Hereinafter, the former is referred to as a “cutout above data line” and the latter is referred to as a “cutout above TFT”. The cutout above data line 32 has a substantially rectangular shape along the data line 24. Further, in FIG. 5, the cutout above data line 32 and the cutout above TFT 33 are formed integrally, and formed corresponding to each pixel circuit 20. Although the common electrode 30 preferably has the cutout above TFT 33, it need not necessarily have the cutout above TFT 33.

The cutout above data line 32 is formed not in a region including the entire placement region for the data line 24, but in a region including a part of the placement region for the data line 24. In other words, in the remaining part of the placement region for the data line 24, the cutout above data line 32 is not formed, and the common electrode 30 exists. For this reason, the common electrode 30 has the shape of being connected in the row direction by a bridge portion 34 shown in FIG. 5. The bridge portion 34 is provided for the following purpose: when there exist two pixel electrodes 22 that are adjacent in the row direction, the bridge portion 34 electrically connect the common electrode 30 facing one pixel electrode 22 and the common electrode 30 facing the other pixel electrode 22 to reduce in-plane variation in resistance of the common electrode 30.

The counter substrate 40 is disposed facing the active matrix substrate 10. As shown in FIG. 6, a black matrix 41 having an opening 42 in a position facing the pixel electrode 22 is formed on the counter substrate 40. The black matrix 41 is formed in a position that faces regions including the TFT 21, the gate line 23, the data line 24, and the cutout above data line 32. Further, the black matrix 41 is formed so as to cover the end of the slit 31.

In order to hold a constant interval between the active matrix substrate 10 and the counter substrate 40, columnar spacers 43 are formed on the counter substrate 40. As shown in FIG. 6, the columnar spacer 43 is formed in a position facing the cutout above data line 32.

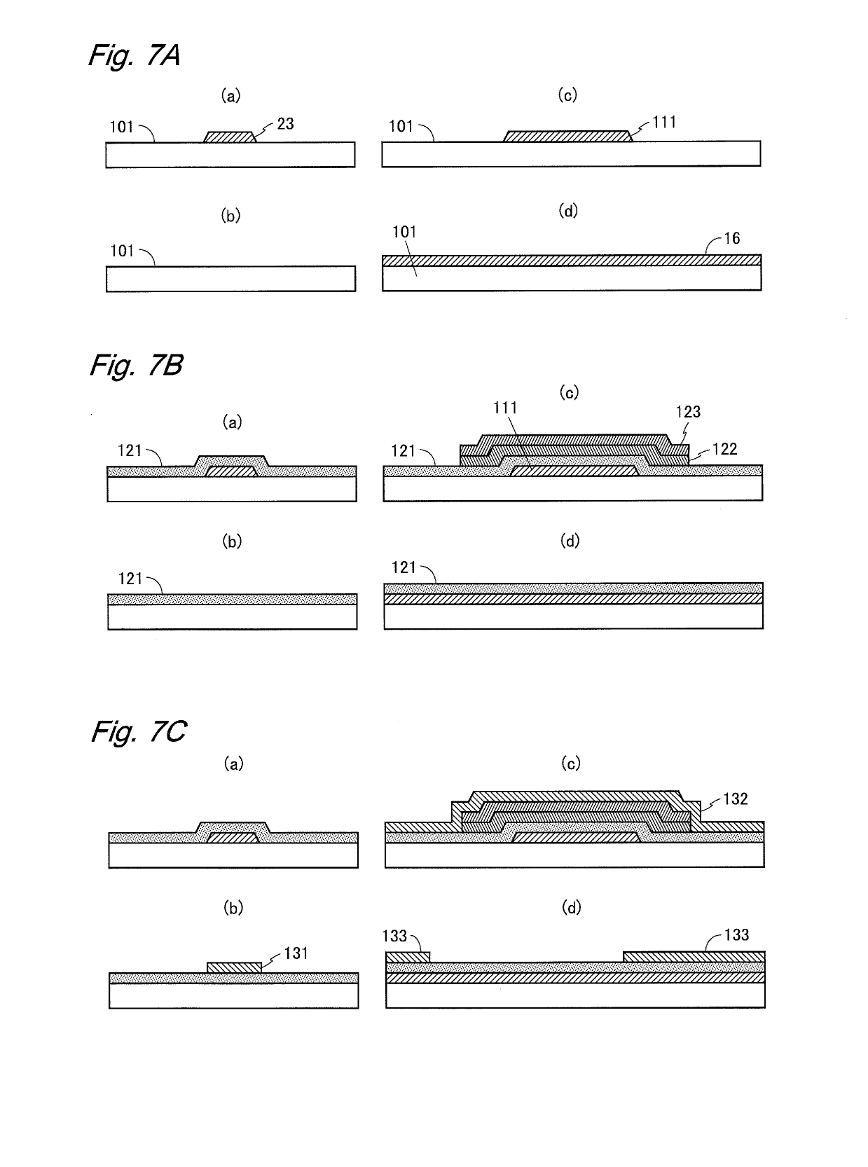

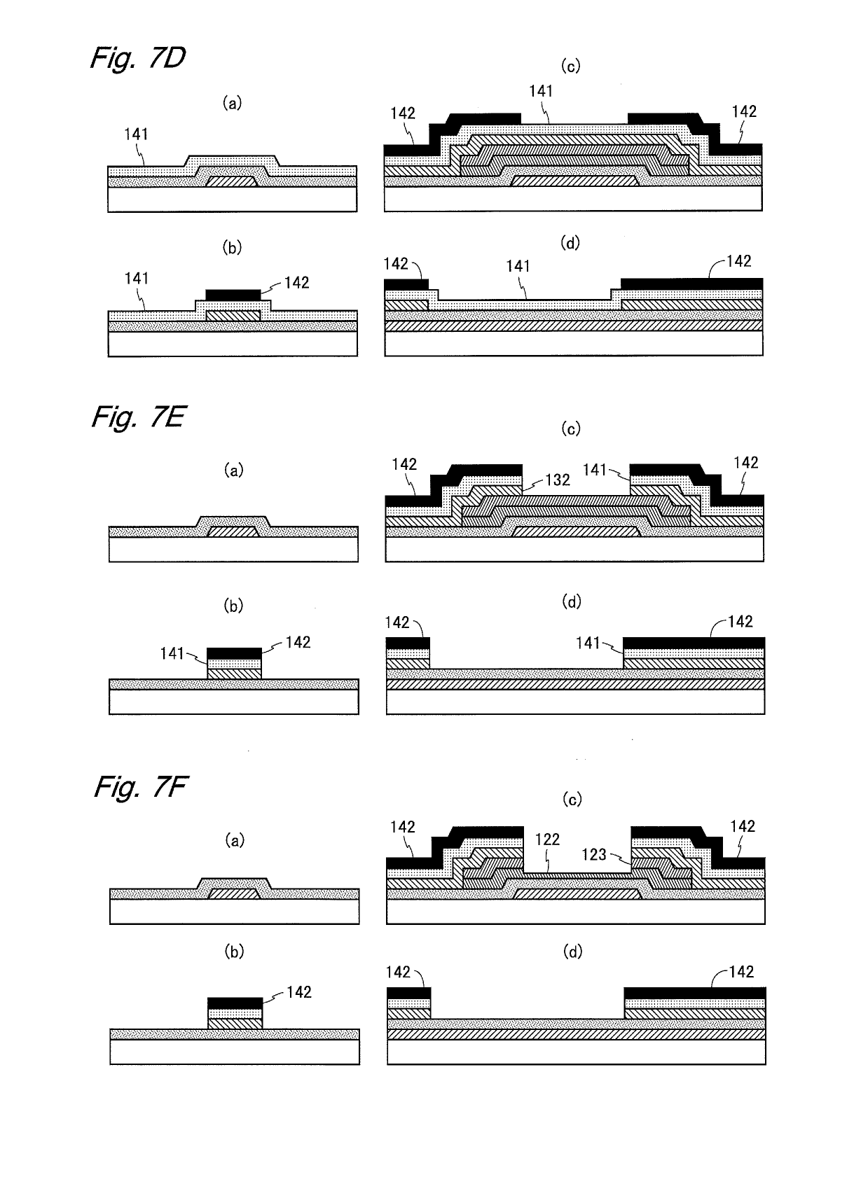

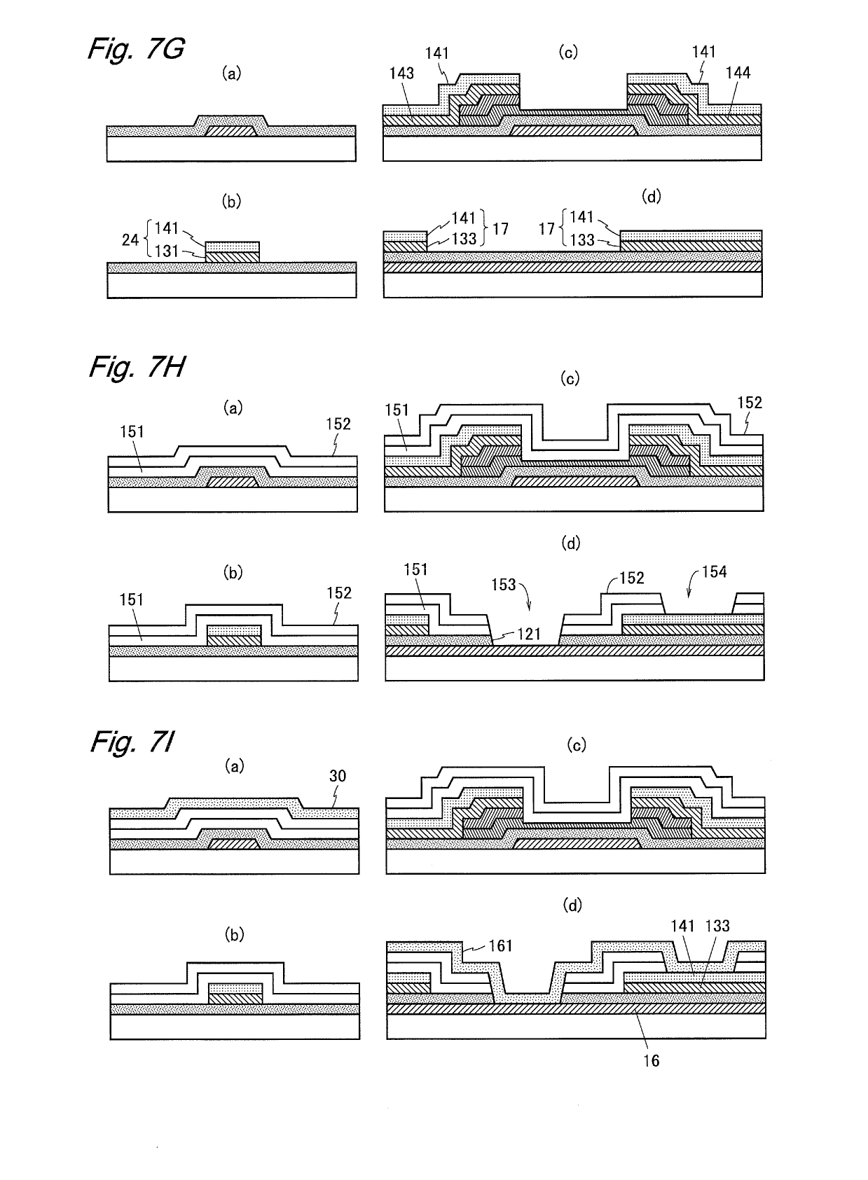

Hereinafter, a method for manufacturing the active matrix substrate 10 is described with reference to FIGS. 7A to 7I. (a) to (d) in FIGS. 7A to 7I each show processes of forming the gate line 23, the data line 24, the TFT 21, and the connecting circuit. In the following description, thicknesses of a variety of films formed on the substrate are preferably decided in accordance with functions, materials, and the like of the films. The thickness of the film is about 10 nm to 1 μm, for example.

(First Process) Formation of Gate Layer Pattern (FIG. 7A)

Ti (titanium), Al (aluminum), and Ti are formed successively on a glass substrate 101 by sputtering. Subsequently, a gate layer is patterned using photolithography and etching to form the gate line 23, the gate electrode 111 of the TFT 21, the first common main wiring 16, and the like. Patterning using photolithography and etching refers to the following processing. First, a photoresist is applied to the substrate. Next, the substrate is covered with a photomask having an intended pattern and is exposed to light, thereby to make a photoresist having the same pattern as that of the photomask remain on the substrate. Subsequently, the substrate is etched using the remaining photoresist as a mask, to form a pattern on the surface of the substrate. Finally, the photoresist is peeled off.

(Second Process) Formation of Semiconductor Layer (FIG. 7B)

A SiNx (silicon nitride) film 121 to be a gate insulating film, an amorphous Si (amorphous silicon) film 122, and an n+amorphous Si film 123 doped with phosphor are successively formed on the substrate shown in FIG. 7A by CVD (Chemical Vapor Deposition). Subsequently, a semiconductor layer is patterned using photolithography and etching, to form a semiconductor layer made up of the amorphous Si film 122 and the n+amorphous Si film 123 in an island shape on the gate electrode 111 of the TFT 21.

(Third Process) Formation of Source Layer Pattern (FIG. 7C)

A MoNb (molybdenum niobium) film is formed on the substrate shown in FIG. 7B by sputtering. Subsequently, a source layer is patterned using photolithography and etching to form a main conductor part 131 of the data line 24, a conductor part 132 of the TFT 21, a main conductor part 133 of the second common main wiring 17, and the like. The conductor part 132 of the TFT 21 is formed in the positions of the source electrode, the drain electrode, and the channel region of the TFT 21. When the third process is completed, the source electrode, the drain electrode, and the channel region of the TFT 21 are formed integrally with the main conductor part 131 of the data line 24.

(Fourth Process) Formation of Pixel Electrode (FIGS. 7D to 7G)

An IZO (Indium-Zinc-Oxide) film 141 to be the pixel electrode 22 is formed on the substrate shown in FIG. 7C by sputtering. Subsequently, the pixel electrode layer is patterned using photolithography and etching. In the fourth process, there is used a photomask for making a photoresist 142 remain in the position of the pixel electrode 22 and the position of the source layer pattern (except for the position of the channel region of the TFT 21). For this reason, after exposure to light, the photoresist 142 remains in the position of the pixel electrode 22 and the position of the source layer pattern except for the position of the channel region of the TFT 21 (FIG. 7D). Using the photoresist 142 as a mask, the IZO film 141 and the conductor part 132 existing in the position of the channel region of the TFT 21 are at first etched by wet etching, and then the n+amorphous Si film 123 existing in the position of the channel region of the TFT 21 is etched by dry etching (FIGS. 7E, 7F). FIG. 7E shows a substrate when etching of the conductor part 132 is completed. FIG. 7F shows a substrate when etching of the n+amorphous Si film 123 is completed. As shown in FIG. 7F, a film thickness of the amorphous Si film 122 existing in the channel region of the TFT 21 becomes thin by dry etching. Finally, the photoresist 142 is peeled off to obtain a substrate shown in FIG. 7G. In the substrate shown in FIG. 7G, the channel region of the TFT 21 is formed, and the source electrode 143, and the drain electrode 144 of the TFT 21 come into a separate state. The IZO film 141 remains in a layer over the main conductor part 131 of the data line 24, the source electrode 143 and the drain electrode 144 of the TFT 21, and the main conductor part 133 of the second common main wiring 17. The main conductor part 131 and the IZO film 141 in a layer thereover form the data line 24. The main conductor part 133 and the IZO film 141 in a layer thereover form the second common main wiring 17.

(Fifth Process) Formation of Protective Insulating Film (FIG. 7H)

Two-layered SiNx films 151, 152 to be the protective insulating film are sequentially formed on the substrate shown in FIG. 7G by CVD. Film formation conditions for the lower SiNx film 151 and film formation conditions for the upper SiNx film 152 are different. For example, a high-density thin film formed under a high temperature condition is used as the lower SiNx film 151, and a low-density thin film formed under a low temperature condition is used as the upper SiNx film 152. Subsequently, the two-layered SiNx films 151, 152 formed in the fifth process and the SiNx film 121 formed in the second process are patterned using photolithography and etching. As shown in FIG. 7H(d), a contact hole 153 penetrating the two-layered SiNx films 151, 152 and the SiNx film 121, and a contact hole 154 penetrating the two-layered SiNx films 151, 152 are formed in a position for forming the connecting circuit.

(Sixth Process) Formation of Common Electrode (FIG. 7I)

An IZO film to be the common electrode 30 is formed on the substrate shown in FIG. 7H by sputtering. Subsequently, a common electrode layer is patterned using photolithography and etching to form the common electrode 30 and a connecting electrode 161. As shown in FIG. 7I(d), the connecting electrode 161 comes into direct contact with the first common main wiring 16 in the position of the contact hole 153, and is electrically connected to the main conductor part 133 of the second common main wiring 17 via the IZO film 141 in the position of the contact hole 154. Further, the connecting electrode 161 is formed integrally with the common electrode 30. Accordingly, the common electrode 30, the first common main wiring 16, and the second common main wiring 17 can be electrically connected by using the connecting electrode 161.

A photomask used in the sixth process has a pattern corresponding to the slit 31, the cutout above data line 32, and the cutout above TFT 33. The use of such a photomask can form the common electrode 30 having the slit 31, the cutout above data line, and the cutout above TFT 33. Although the common electrode 30 is not formed over the data line 24 in FIG. 7I(b), the common electrode 30 is formed over the data line 24 in the bridge portion 34 shown in FIG. 5. By performing the first to sixth processes described above, it is possible to manufacture the active matrix substrate 10 having a sectional structure shown in FIG. 7I.

In the manufacturing method according to the present embodiment, photolithography is performed using different photomasks in the first to sixth processes. The number of photomasks used in the manufacturing method according to the present embodiment is six in total. When the gate line is formed in the first process and when the main conductor part 131 of the data line 24 is formed in the third process, Cu (copper), Mo (molybdenum), Al, Ti, TiN (titanium nitride), an alloy of these, or a laminated film of these metals may be used in place of the above materials. For example, as the wiring materials for the gate line 23 and the main conductor part 131 of the data line 24, there may be used a three-layered film formed by laminating an Al alloy in a layer over MoNb, and further laminating MoNb in a layer over the Al alloy. Further, when the pixel electrode 22 is formed in the fourth process and when the common electrode 30 is formed in the sixth process, ITO (Indium Tin Oxide) may be used in place of IZO. Moreover, when the protective insulating film is formed in the fifth process, a one-layered SiNx film may be formed in place of the two-layered SiNx films. Alternatively, SiOx (silicon oxide) films, SiON (silicon oxy-nitride) films, or laminated films of these may be used in place of the SiNx films.

The counter substrate 40 is formed by forming, on the glass substrate, the black matrix 41 with the opening 42, forming a color filter layer and an overcoat layer thereon, and further providing the columnar spacer 43 in the position facing the cutout above data line 32. Further, each of the surface on the liquid crystal layer side of the active matrix substrate 10 and the surface on the liquid crystal layer side of the counter substrate 40 is provided with a horizontal alignment film (not shown), and is subjected to surface treatment for setting initial alignment direction of liquid crystal molecules. The liquid crystal panel 2 can be configured by disposing the active matrix substrate 10 and the counter substrate 40 so as to face each other, and providing the liquid crystal layer between the two substrates.

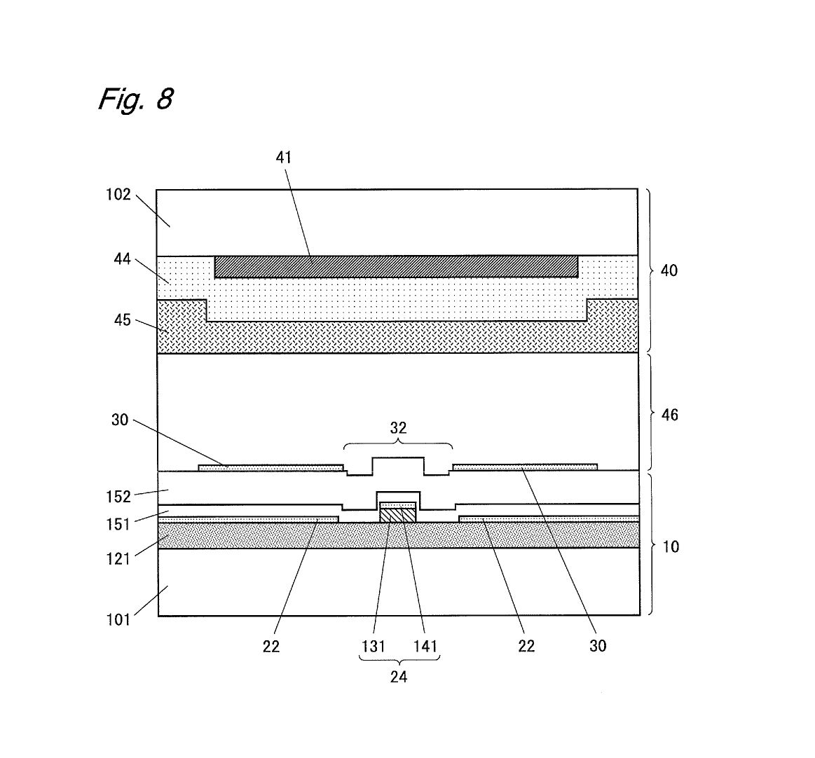

FIG. 8 is a sectional view of the liquid crystal panel 2. FIG. 8 shows a cross section taken along line B-B′ of FIG. 3. The active matrix substrate 10 has the following configuration on the line B-B′. The SiNx film 121 to function as the gate insulating film is formed on the glass substrate 101, and the pixel electrode 22 and the data line 24 are formed in predetermined positions on the SiNx film 121. The data line 24 includes the main conductor part 131 and the IZO film 141. The IZO film 141 is formed in a layer over the main conductor part 131 together with the pixel electrode 22 in the above-described fourth process. Two-layered SiNx films 151, 152 to function as the protective insulating film are formed in a layer over the pixel electrode 22 and the data line 24. The common electrode 30 is formed in a predetermined position on the upper SiNx film 152. The common electrode has the cutout above data line 32, and the common electrode 30 does not exist over the data line 24.

The black matrix 41 is formed on one surface of a glass substrate 102 of the counter substrate 40. A color filter layer 44 and an overcoat layer 45 are formed on the surface of the glass substrate 102 where the black matrix is formed. The active matrix substrate 10 and the counter substrate 40 are disposed facing each other, and a liquid crystal layer 46 is provided between the two substrates. Note that the horizontal alignment films are omitted in FIG. 8.

Hereinafter, effects of the active matrix substrate 10 and the liquid crystal panel 2 according to the present embodiment are described. The common electrode 30 of the active matrix substrate 10 has the cutout above data line 32 formed in a region including a part of the placement region for the data line 24. For this reason, the common electrode 30 does not exist over the part of the placement region for the data line 24. Thus, according to the active matrix substrate 10, it is possible to reduce parasitic capacitance that is generated between the data line 24 and the common electrode 30, and reduce a load (capacitance) of the data line 24. It is thereby possible to prevent display failure such as a luminance decrease and luminance unevenness caused by the load of the data line 24.

Further, the common electrode 30 has the cutout above TFT 33 formed in a region including the placement region for the source electrode and the channel region of the TFT 21. For this reason, the common electrode 30 does not exist also over the placement region for the source electrode and the channel region of the TFT 21. Hence, it is possible to reduce parasitic capacitance that is generated between the common electrode 30 and the placement region for the source electrode/the channel region of the TFT 21, and further reduce the load of the data line 24. It is thus possible to more effectively prevent the display failure caused by the load of the data line 24.

When an electrode is provided over the TFT 21, the provided electrode may affect the operation of the TFT 21. For example, providing the electrode may cause an increase in off-leak current of the TFT 21. The common electrode 30 of the active matrix substrate 10 has the cutout above TFT 33. Thus, according to the active matrix substrate 10, it is possible to reduce the off-leak current of the TFT 21.

Further, the common electrode 30 has the bridge portion 34. Hence, the common electrode 30 facing one pixel electrode 22 and the common electrode 30 facing another pixel electrode 22 adjacent to the one pixel electrode 22 in the row direction are electrically connected by the bridge portion 34. It is thus possible to reduce in-plane variation in resistance of the common electrode 30 and reduce display failure such as shadowing.

Further, the IZO film 141 formed through the same process as that for the pixel electrode 22 exists in the layer over the main conductor part 131 of the data line 24. As thus described, the data line 24 has a laminate structure made up of the main conductor part 131 and the IZO film 141. The use of such a laminate structure can reduce the resistance of the data line 24 and reduce rounding of a signal inputted into the data line 24.

In the active matrix substrate 10, due to provision of the cutout above data line 32 in the common electrode 30, the alignment of liquid crystal molecules in the vicinity of the data line 24 is disordered under the influence of the electric field generated by the signal on the data line 24. In order to hide the influence of the alignment disorder, the black matrix 41 of the counter substrate 40 is formed in a position that faces a region including the placement region for the cutout above data line 32. Thus, according to the liquid crystal panel 2 of the present embodiment, it is possible to hide the influence (afterimage, contrast degradation, etc.) of the alignment disorder due to provision of the cutout above data line 32.

Note that the region in the vicinity of the data line 24 originally has low contribution to the transmittance (since the data line 24 is opaque and the alignment disorder due to the thickness of the data line 24 easily occurs in this region). For this reason, even when this region is hidden by the black matrix 41, the transmittance does not decrease greatly. Especially in the liquid crystal panel 2 having horizontally long pixels, the region in the vicinity of the data line 24 has low contribution to the transmittance.

Further, the columnar spacer 43 is disposed in a position facing the cutout above data line 32. Hence, the columnar spacer 43 is disposed in a position covered with the black matrix 41 (see FIG. 6). Thus, according to the liquid crystal panel 2 of the present embodiment, there is no need to dispose an extra portion of the black matrix 41 for hiding the influence of the alignment disorder due to the columnar spacer 43. Moreover, the portion where the data line 24 is formed is flatter than the portion where the TFT 21 is formed. Thus, according to the liquid crystal panel 2, the constant interval between the active matrix substrate 10 and the counter substrate 40 can be held stably.

As shown above, the active matrix substrate 10 according to the present embodiment includes the plurality of gate lines 23 extending in a first direction (row direction); the plurality of data lines 24 extending in a second direction (column direction); the plurality of pixel circuits 20 arranged corresponding to intersections of the gate lines and the data lines and each including a switching element (TFT 21) and the pixel electrode 22; the protective insulating film (SiNx films 151, 152) formed in a layer over the gate line 23, the data line 24, the switching element, and the pixel electrode 22; and the common electrode 30 formed in a layer over the protective insulating film. The common electrode 30 has the cutout above data line 32 that is formed in a region including a part of the placement region for the data line 24 and has the portion extending in the second direction. According to the active matrix substrate 10 of the present embodiment, forming the cutout above data line 32 in the common electrode 30 can reduce the load (capacitance) of the data line 24 and prevent the display failure, such as a luminance decrease and luminance unevenness, caused by the load of the data line 24.

Further, the common electrode 30 has a cutout above the switching element (cutout above TFT 33), the cutout above the switching element formed in a region including the placement region for a data-line-side electrode of the switching element (source electrode of the TFT 21) and the channel region of the switching electrode. It is thereby possible to reduce parasitic capacitance that is generated between the common electrode 30 and the data-line-side electrode/the channel region of the switching element, and further reduce the load of the data line 24. The cutout above data line 32 and the cutout above the switching element are formed integrally. Hence, the load of the data line 24 can be reduced more than in the case of separately forming the two kinds of cutouts. Further, the cutout above data line 32 and the cutout above the switching element are formed corresponding to each pixel circuit 20. It is thus possible to reduce the in-plane variation in resistance of the common electrode 30 and make the voltage of the common electrode 30 constant without depending on its location. Moreover, the data line 24 is a wiring formed by laminating a plurality of materials, and a first material (IZO) included in the plurality of materials is the same as the material for the pixel electrode 22. As thus described, the use of the data line 24 which has a layer formed of the same material as that for the pixel electrode 22, can reduce the resistance of the data line 24.

Further, the common electrode 30 has the plurality of slits 31 extending in the first direction corresponding to each pixel electrode 22. Hence, the lateral electric field can be applied to the liquid crystal layer by using the common electrode 30 and the pixel electrode 22. Moreover, the length of the pixel circuit 20 in the first direction is longer than the length of the pixel circuit 20 in the second direction. Accordingly, even when the length of the pixel circuit 20 in the direction in which the gate line 23 extends is longer than that in the direction in which the data line 24 extends and the display failure caused by the load of the data line 24 occurs easily, forming the cutout above data line 32 in the common electrode 30 can reduce the load of the data line 24 and prevent the display failure caused by the load of the data line 24. Furthermore, the switching element has a control electrode (gate electrode) connected to the gate line 23, a first conductive terminal (source electrode) connected to the data line 24, and a second conductive terminal (drain electrode) connected to the pixel electrode 22. Accordingly, in the active matrix substrate 10 where the switching element is connected to the gate line 23, the data line 24, and the pixel electrode 22, it is possible to prevent the display failure caused by the load of the data line 24.

Further, the liquid crystal panel 2 according to the present embodiment includes the active matrix substrate 10, and the counter substrate 40 that is disposed facing the active matrix substrate 10 and has the black matrix 41. The black matrix 41 is formed in a position that faces a region including the placement regions for the gate line 23, the data line 24, the switching element, and the cutout above data line 32. As thus described, the black matrix 41 is formed on the counter substrate 40 while facing the cutout above data line 32, thus making it possible to hide the influence of the alignment disorder due to provision of the cutout above data line 32. Moreover, the counter substrate 40 has the columnar spacer 43 in the position facing the cutout above data line 32. This eliminates the need to dispose an extra portion of the black matrix 41 for hiding the influence of the alignment disorder due to the columnar spacer 43. Since the portion where the data line 24 is formed is flatter than the portion where the TFT 21 is formed, the constant interval between the active matrix substrate 10 and the counter substrate 40 can be held stably.

The above-described method for manufacturing the active matrix substrate 10 includes: a step (first to fourth processes) of forming the plurality of gate lines 23 extending in the first direction, the plurality of data lines 24 extending in the second direction, and the plurality of pixel circuits 20 arranged corresponding to intersections of the gate lines 23 and the data lines 24 and each including the switching element and the pixel electrode 22; a step (fifth process) of forming the protective insulating film formed in the layer over the gate line 23, the data line 24, the switching element, and the pixel electrode 22; and a step of forming, in the layer over the protective insulating film, the common electrode 30 having the cutout above data line 32 that is formed a the region including a part of the placement region for the data line 24 and has the portion extending in the second direction, and the slit 31 for generating a lateral electric field. According to the method for manufacturing the active matrix substrate 10 of the present embodiment, the cutout above data line 32 is formed through the same process as that for the slit 31 for generating a lateral electric field to prevent the display failure caused by the load of the data line 24, thereby allowing manufacturing of the active matrix substrate 10 provided with the common electrode 30 having the cutout above data line 32, without increasing the number of processes.

Further, the step of forming the gate line 23, the data line 24, and the pixel circuit 20 includes a step (fourth process) of forming, together with the pixel electrode 22, a layer (IZO film 141) of the data line 24, the layer being formed of the first material. As thus described, one layer from among the data lines 24 is formed of the first material together with the pixel electrode 22, to allow manufacturing of the active matrix substrate 10 with reduced resistance of the data lines 24, without increasing the number of processes.

### Second Embodiment

An active matrix substrate according to a second embodiment of the present invention includes TFTs, pixel electrodes, gate lines, data lines, and a common electrode which have different shapes from those in the first embodiment. Hereinafter, a difference from the first embodiment is described, and descriptions of common points with the first embodiment are omitted.

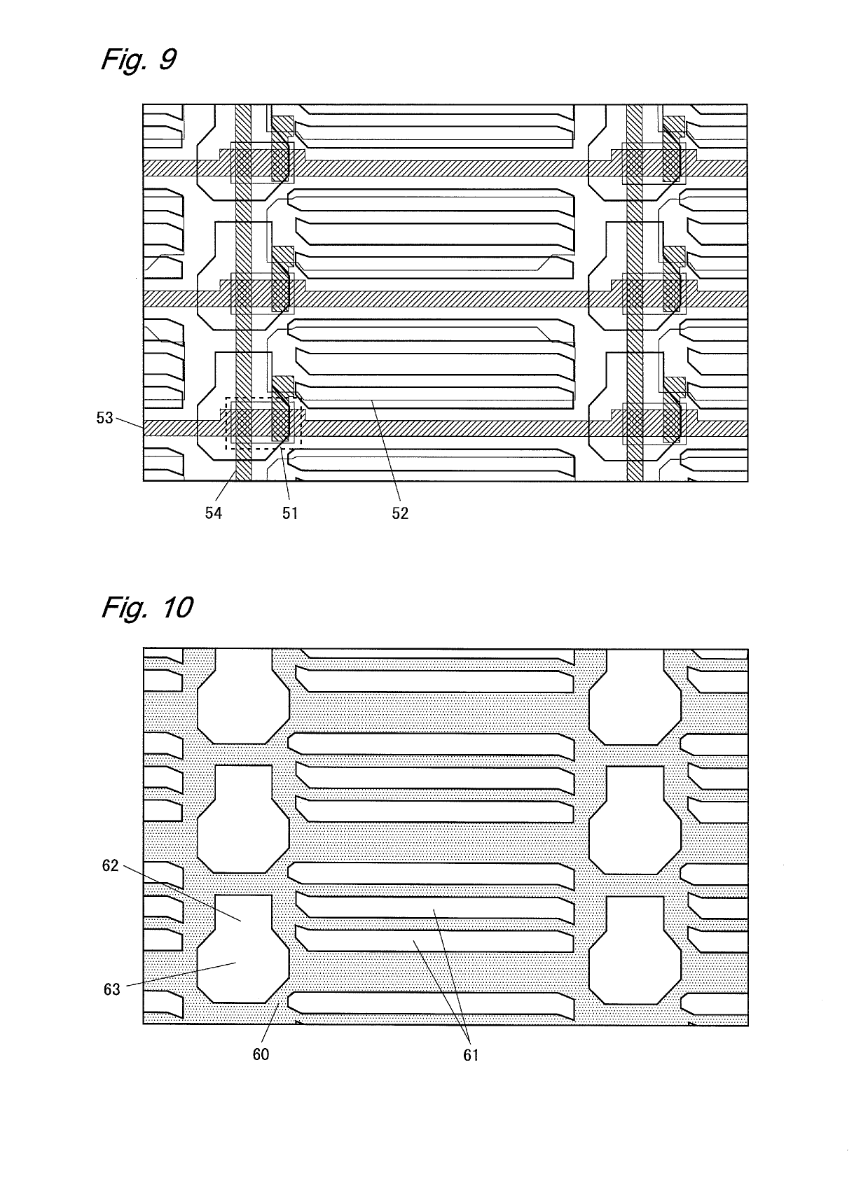

FIG. 9 is a layout diagram of an active matrix substrate according to the present embodiment. FIG. 10 is a diagram showing a pattern of a common electrode of the active matrix substrate according to the present embodiment. In FIG. 9, for facilitating understanding of the drawing, patterns other than a pattern of the common electrode are indicated by thin lines.

As shown in FIG. 9, a gate line 53 (left down oblique line part) extends in the row direction without bending. A data line 54 (right down oblique line part) extends in the column direction without bending. A TFT 51 (broken line part) is formed in the vicinity of the intersection of the gate line 53 and the data line 54. A pixel electrode 52 is formed in a region separated by the gate lines 53 and the data lines 54. The length of the pixel electrode 52 in the row direction is longer than that in the column direction. As with the first embodiment, the length of the pixel circuit in the row direction is longer than the length of the pixel circuit in the column direction.

A common electrode 60 is formed in a layer over a protective insulating film which is formed in a layer over the TFT 51, the pixel electrode 52, the gate line 53, and the data line 54. As shown in FIG. 10, the common electrode 60 has three slits 61 corresponding to one pixel electrode 52. Further, the common electrode 60 has a cutout above data line 62 that is formed in a region including a part of a placement region for the data line 54 and has a portion extending in the column direction, and a cutout above TFT 63 formed in a region including a placement region for a source electrode and a channel region of the TFT 51. The cutout above data line 62 and the cutout above TFT 63 are formed integrally, and formed corresponding to each pixel circuit.

In the liquid crystal panel 2 according to the first embodiment, the bent slits 31 are formed in the common electrode 30 so as to widen a view angle. However, when a bending point is provided to the slit 31, the gate line 23 parallel to the slit 31 becomes long to increase the resistance of the gate line 23. Further, since the vicinity of the bending point of the slit 31 has low contribution to the transmittance, providing the bending point on the slit 31 decreases the transmittance of the liquid crystal panel 2.

In contrast, in the liquid crystal panel according to the present embodiment, the linear slits 61 are formed in the common electrode 60. Thus, according to the liquid crystal panel of the present embodiment, the gate line 53 can be shortened to reduce the resistance of the gate line 53 and increase the transmittance of the liquid crystal panel.

The size of the TFT included in the pixel circuit of the liquid crystal panel can be decided in accordance with a pixel size, and the like. For example, when the pixel size is small, the size of the TFT may be small. In such a case, the TFT 51, the pixel electrode 52, the gate line 53, the data line 54, and the common electrode 60 which have simple shapes shown in FIG. 9 can be used in place of the TFT 21, the pixel electrode 22, the gate line 23, the data line 24, and the common electrode 30 which have complex shapes shown in FIGS. 3 to 6.

As thus described, also in the active matrix substrate including the TFT 51, the pixel electrode 52, the gate line 53, the data line 54, and the common electrode 60 which have different shapes from those in the first embodiment, forming the cutout above data line 62 in the common electrode 60 can reduce a load of the data line 54 and prevent display failure caused by the load of the data line 54.

### Third Embodiment

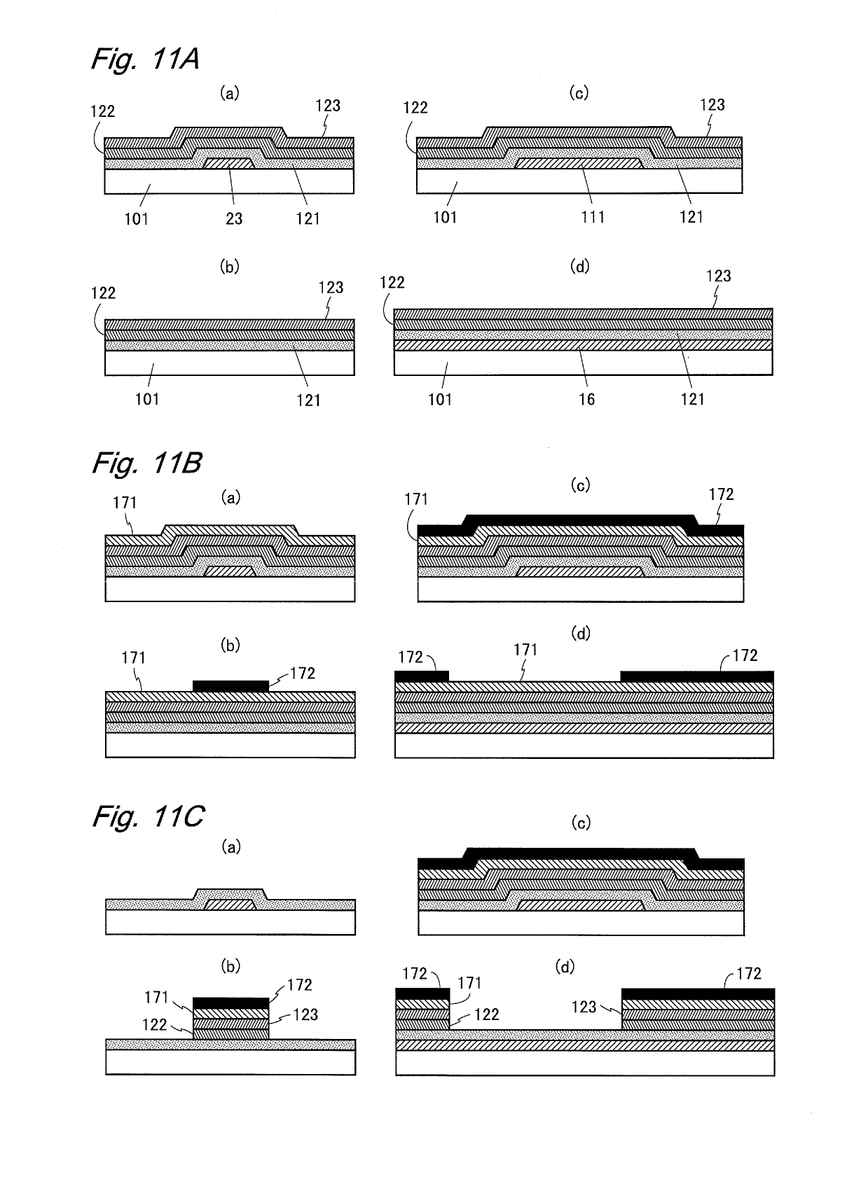

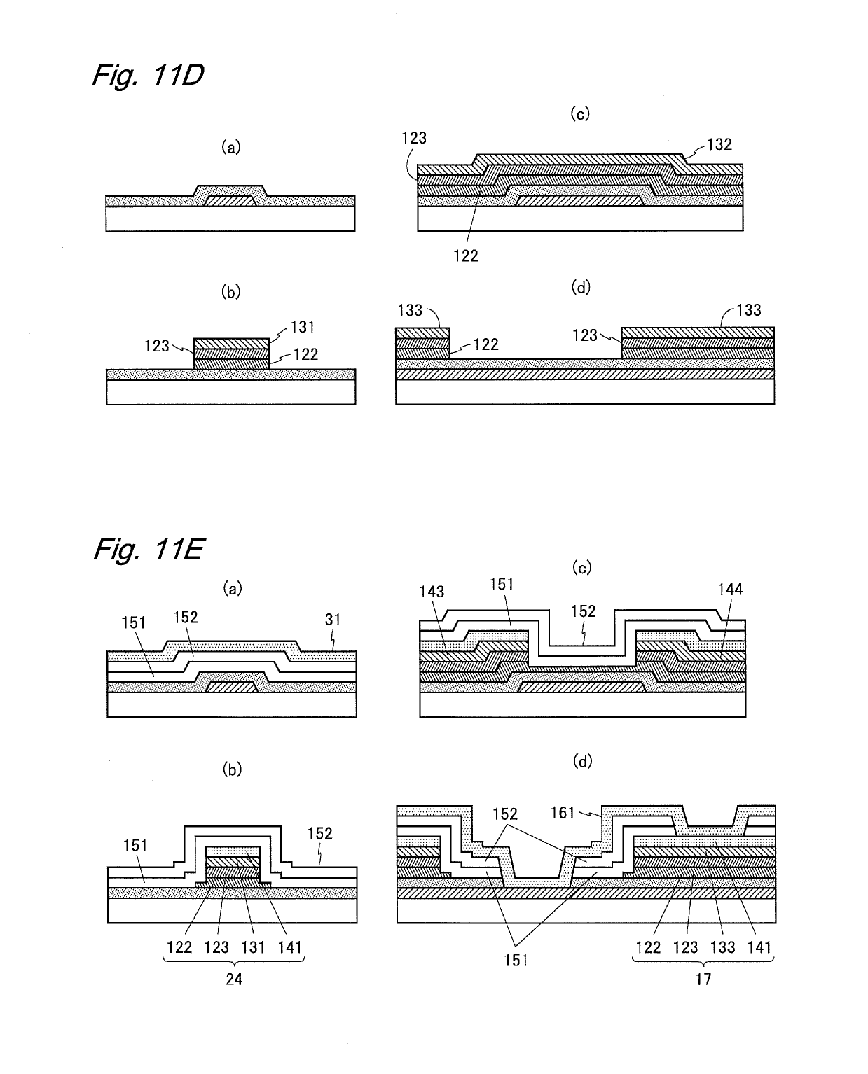

In a third embodiment of the present invention, a description is given of a method for manufacturing an active matrix substrate provided with a common electrode having a cutout above data line, in a different manner from the first embodiment. In the manufacturing method according to the present embodiment, the first process described in the first embodiment is performed, second and third processes shown below are performed, and the fourth to sixth processes described in the first embodiment are performed. Hereinafter, with reference to FIGS. 11A to 11D, the second and third processes of the manufacturing method according to the present embodiment are described. Note that the same elements as those in the first embodiment are provided with the same numerals, and descriptions thereof are omitted.

(Second Process) Formation of Semiconductor Layer (FIG. 11A)

The SiNx film 121 to be a gate insulating film, the amorphous Si film 122, and the n+amorphous Si film 123 doped with phosphor are successively formed on the substrate shown in FIG. 7A by CVD. Unlike the first embodiment, in the present embodiment, the semiconductor layer is not patterned. The patterning of the semiconductor layer is performed together with patterning of the source layer in the third process.

(Third Process) Formation of Source Layer Pattern (FIG. 11B to FIG. 11D)

A MoNb film 171 is formed on the substrate shown in FIG. 11A by sputtering. Subsequently, the source layer and the semiconductor layer are patterned using photolithography and etching to form the main conductor part 131 of the data line 24, the conductor part 132 of the TFT 21, the main conductor part 133 of the second common main wiring 17, and the like. The conductor part 132 of the TFT 21 is formed in the positions of the source electrode, the drain electrode, and the channel region of the TFT 21. In the third process, there is used a photomask for making a photoresist 172 remain in the positions of the main conductor parts 131, 133, the conductor part 132, and the like. For this reason, after exposure to light, the photoresist 172 remains in the positions of the main conductor parts 131, 133, the conductor part 132, and the like (FIG. 11B). Using the photoresist 172 as a mask, the MoNb film 171 formed in the third process is at first etched, and then the n+amorphous Si film 123 and the amorphous Si film 122 formed in the second process are etched successively (FIG. 11C). The amorphous Si film 122 and the n+amorphous Si film 123 are thereby patterned in almost the same shape as that of the source layer. Finally, the photoresist 172 is peeled off to obtain a substrate shown in FIG. 11D. In the substrate shown in FIG. 11D, the remaining unattached MoNb film 171 becomes the main conductor part 131 of the data line 24, the conductor part 132 of the TFT 21, the main conductor part 133 of the second common main wiring 17, and the like. The substrate shown in FIG. 11D corresponds to the substrate shown in FIG. 7C. The substrate shown in FIG. 11D is different from the substrate shown in FIG. 7C in that the amorphous Si film 122 and the n+amorphous Si film 123 exist in layers under the main conductor part 131 of the data line 24 and the main conductor part 133 of the second common main wiring 17.

By performing the fourth to sixth processes described in the first embodiment on the substrate shown in FIG. 11D, it is possible to manufacture an active matrix substrate with a sectional structure shown in FIG. 11E. A liquid crystal panel according to the present embodiment can be configured by disposing the active matrix substrate and the counter substrate 40 so as to face each other and providing a liquid crystal layer between the two substrates.

Note that in the method for manufacturing the active matrix substrate according to the present embodiment, when the gate line 23 is formed in the first process and when the main conductor part 131 of the data line 24 is formed in the third process, Cu, Mo, Al, Ti, an alloy of these, or a laminated film of these metals may be used. Further, when the pixel electrode 22 is formed in the fourth process and when the common electrode 30 is formed in the sixth process, ITO may be used. Moreover, when the protective insulating film is formed in the fifth process, a one-layered SiNx film may be formed, or a SiOx film, a SiON film, or a laminated film of these may be used.

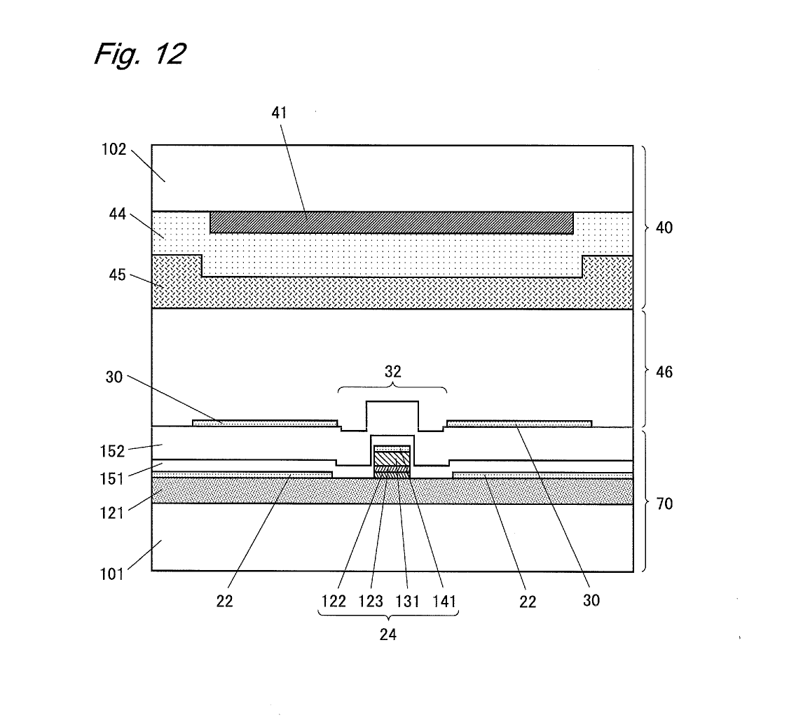

FIG. 12 is a sectional view of the liquid crystal panel according to the present embodiment. As with FIG. 8, FIG. 12 shows a sectional view of the data line 24. An active matrix substrate 70 according to the present embodiment is different from the active matrix substrate 10 according to the first embodiment in that the amorphous Si film 122 and the n+amorphous Si film 123 exist in layers under the main conductor part 131 of the data line 24. Hence, in the active matrix substrate 70, the thickness of the data line 24 is larger by the thicknesses of the amorphous Si film 122 and the n+amorphous Si film 123.

In the manufacturing method according to the present embodiment, photolithography is performed using different photomasks in the first and third to sixth processes, and photolithography is not performed in the second process. The number of photomasks used in the manufacturing method according to the present embodiment is five in total. Thus, according to the manufacturing method of the present embodiment, the number of photomasks to be used can be reduced by one from the manufacturing method according to the first embodiment, and manufacturing cost can thus be reduced.

Further, the IZO film 141 exists in a layer over the main conductor part 131 of the data line 24, and the amorphous Si film 122 and the n+amorphous Si film 123 exist in layers under the main conductor part 131 of the data line 24. As thus described, the data line 24 has a laminate structure made up of the amorphous Si film 122, the n+amorphous Si film 123, the main conductor part 131, and the IZO film 141. With the use of the data line 24 having a layer (amorphous Si film 122 and n+amorphous Si film 123) formed of the same material as that for the semiconductor layer of the switching element (TFT 21) in addition to a layer (IZO film 141) formed of the same material as that for the pixel electrode 22 as thus described, it is possible to further reduce the resistance of the data line 24, and further reduce rounding of a signal inputted into the data line 24.

Further, the plurality of materials for forming the data line 24 includes a second material (amorphous Si and n+amorphous Si), and a step (first to fourth processes) of forming the gate line 23, the data line 24, and the pixel circuit 20 includes a step (second and third processes) of forming, together with the semiconductor layer of the switching element, a layer (amorphous Si film 122 and n+amorphous Si film 123) of the data line 24, the layer being formed of the second material. As thus described, another layer of the data line 24 is formed of the second material, together with the semiconductor layer of the switching element, to allow manufacturing of the active matrix substrate 10 with reduced resistance of the data line 24, without increasing the number of processes.

### Fourth Embodiment

An active matrix substrate according to a fourth embodiment of the present invention is provided with a common electrode having a different shape from that in the first embodiment. Hereinafter, a difference from the first embodiment is described, and descriptions of common points with the first embodiment are omitted.

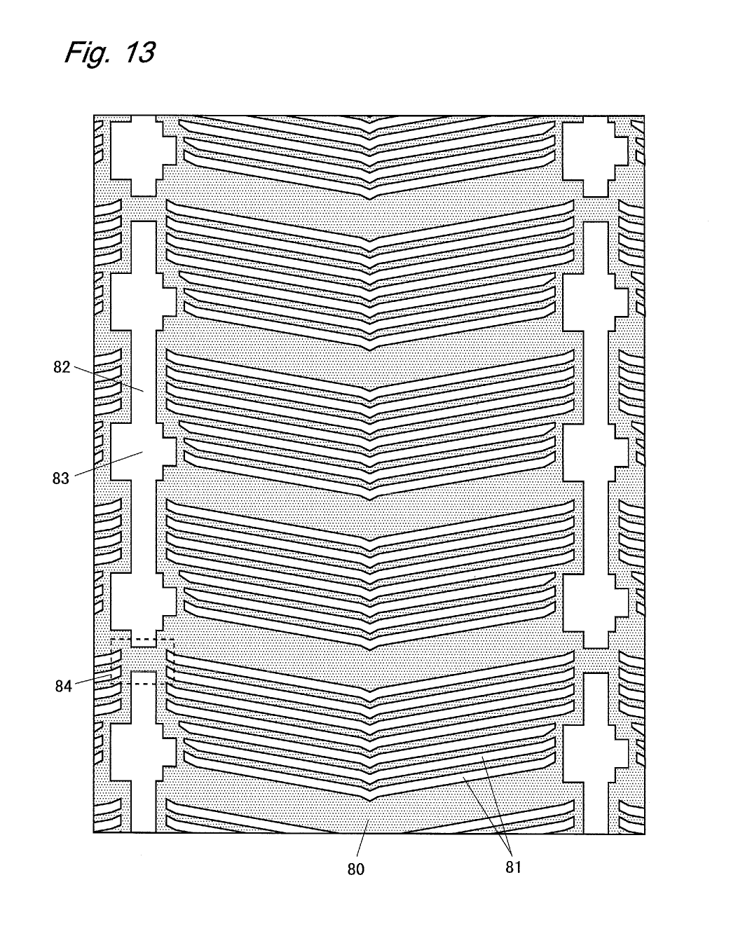

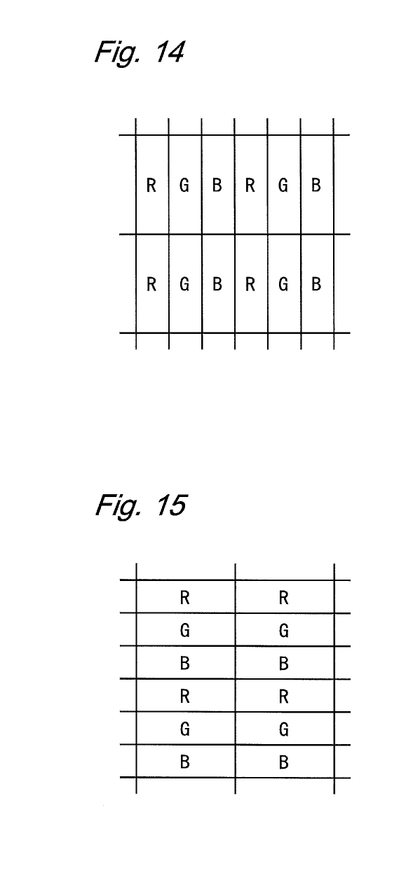

FIG. 13 is a diagram showing a pattern of the common electrode of the active matrix substrate according to the present embodiment. A common electrode 80 shown in FIG. 13 has seven slits 81 corresponding to one pixel electrode. The common electrode 80 has cutouts above data lines 82 and cutouts above TFTs 83. In the present embodiment, three cutouts above data lines 82 and three cutouts above TFTs 83 are formed integrally. The common electrode 80 has one bridge portion 84 corresponding to three pixel circuits that are adjacent in the column direction. As thus described, in the present embodiment, the cutout above data line 82 and the cutout above TFT 83 are formed corresponding to each three pixel circuits that are adjacent in the column direction.

The common electrode 80 has a small area of a portion overlapping the data line, as compared with the common electrode 30 according to the first embodiment. Thus, according to the active matrix substrate of the present embodiment, it is possible to further reduce parasitic capacitance between the data line and the common electrode 80, and further effectively reduce the display failure caused by a load of the data line.

In a small-sized liquid crystal panel, an influence exerted by the in-plane variation in resistance of the common electrode on image quality of a display image is small. The present embodiment is preferably applicable to a small-sized and high definition liquid crystal panel (including a large number of intersections of the gate lines and the data lines).

As shown above, in the active matrix substrate according to the present embodiment, the cutout above data line 82 and the cutout above the switching element (cutout above TFT 83) are formed corresponding to a plurality of pixel circuits that are adjacent in the second direction (column direction). It is thus possible to further reduce the load of the data line.

Note that the active matrix substrates according to the second and fourth embodiments may be manufactured using the manufacturing method according to the first embodiment, or may be manufactured using the manufacturing method according to the third embodiment. Although the description has so far been given of the case of applying the present invention to the liquid crystal panel of the FFS mode which has horizontally long pixels, the present invention is also applicable to a liquid crystal panel having vertically long pixels, and a liquid crystal panel of a vertical alignment mode which uses a vertical alignment film and a lateral electric field.

### INDUSTRIAL APPLICABILITY

The active matrix substrate of the present invention has a feature of being able to reduce display failure caused by a load of the data line, and can thus be used for a liquid crystal panel and the like. The liquid crystal panel of the present invention can be used for a liquid crystal display device, and display units of a variety of electric devices.

### DESCRIPTION OF REFERENCE CHARACTERS

1: LIQUID CRYSTAL DISPLAY DEVICE
2: LIQUID CRYSTAL PANEL
3: DISPLAY CONTROL CIRCUIT
4: GATE LINE DRIVE CIRCUIT
5: DATA LINE DRIVE CIRCUIT
6: BACKLIGHT
10, 70: ACTIVE MATRIX SUBSTRATE
11: COUNTER REGION
13: DISPLAY REGION
20: PIXEL CIRCUIT
21, 51: TFT
22, 52: PIXEL ELECTRODE
23, 53: GATE LINE
24, 54: DATA LINE
30, 60, 80: COMMON ELECTRODE
31, 61, 81: SLIT
32, 62, 82: CUTOUT ABOVE DATA LINE
33, 63, 83: CUTOUT ABOVE TFT
34, 84: BRIDGE PORTION
40: COUNTER SUBSTRATE
41: BLACK MATRIX
42: OPENING
43: COLUMNAR SPACER
46: LIQUID CRYSTAL LAYER
121, 151, 152: SiNx FILM
122: AMORPHOUS Si FILM
123: n+AMORPHOUS Si FILM
131, 133: MAIN CONDUCTOR PART
141: IZO FILM

1. An active matrix substrate comprising:
a plurality of gate lines extending in a first direction;
a plurality of data lines extending in a second direction;
a plurality of pixel circuits arranged corresponding to intersections of the gate lines and the data lines and each including a switching element and a pixel electrode;
a protective insulating film formed in a layer over the gate line, the data line, the switching element, and the pixel electrode; and
a common electrode formed in a layer over the protective insulating film, wherein
the common electrode has a cutout above the data line, the cutout above the data line being formed in a region including a part of a placement region for the data line and having a portion extending in the second direction.

2. The active matrix substrate according to claim 1, wherein the common electrode further has a cutout above the switching element, the cutout above the switching element being formed in a region including a placement region for a data-line-side electrode and a channel region of the switching element.

3. The active matrix substrate according to claim 2, wherein the cutout above the data line and the cutout above the switching element are formed integrally.

4. The active matrix substrate according to claim 3, wherein the cutout above the data line and the cutout above the switching element are formed corresponding to each pixel circuit.

5. The active matrix substrate according to claim 3, wherein the cutout above the data line and the cutout above the switching element are formed corresponding to a plurality of pixel circuits that are adjacent in the second direction.

6. The active matrix substrate according to claim 1, wherein
the data line is a wiring formed by laminating a plurality of materials, and
a first material included in the plurality of materials is the same as a material for the pixel electrode.

7. The active matrix substrate according to claim 6, wherein
the switching element includes a semiconductor layer, and
a second material included in the plurality of materials is the same as the material for the semiconductor layer.

8. The active matrix substrate according to claim 1, wherein the common electrode has a plurality of slits extending in the first direction, corresponding to the pixel electrode.

9. The active matrix substrate according to claim 1, wherein a length of the pixel circuit in the first direction is longer than a length of the pixel circuit in the second direction.

10. The active matrix substrate according to claim 1, wherein the switching element includes a control electrode connected to the gate line, a first conductive electrode connected to the data line, and a second conductive electrode connected to the pixel electrode.

11. A liquid crystal panel comprising:
an active matrix substrate; and
a counter substrate that is disposed facing the active matrix substrate and has a black matrix, wherein
the active matrix substrate includes:
a plurality of gate lines extending in a first direction;
a plurality of data lines extending in a second direction;
a plurality of pixel circuits arranged corresponding to intersections of the gate lines and the data lines and each including a switching element and a pixel electrode;
a protective insulating film formed in a layer over the gate line, the data line, the switching element, and the pixel electrode; and
a common electrode formed in a layer over the protective insulating film,
the common electrode has a cutout above the data line, the cutout above the data line being formed in a region including a part of a placement region for the data line and having a portion extending in the second direction, and
the black matrix is formed in a position that faces a region including placement regions for the gate line, the data line, the switching element, and the cutout above the data line.

12. The liquid crystal panel according to claim 11, wherein the counter substrate has a columnar spacer in a position corresponding to the cutout above the data line.

13. A method for manufacturing an active matrix substrate, the method comprising the steps of:
forming a plurality of gate lines extending in a first direction, a plurality of data lines extending in a second direction, and a plurality of pixel circuits arranged corresponding to intersections of the gate lines and the data lines and each including a switching element and a pixel electrode;
forming a protective insulating film formed in a layer over the gate line, the data line, the switching element, and the pixel electrode; and
forming, in a layer over the protective insulating film, a common electrode having a cutout above the data line, the cutout above the data line being formed in a region including a part of a placement region for the data line and having a portion extending in the second direction, and a slit for generating a lateral electric field.

14. The method for manufacturing an active matrix substrate according to claim 13, wherein
the data line is a wiring formed by laminating a plurality of materials including a first material, and
the step of forming the gate line, the data line, and the pixel circuit includes a step of forming, together with the pixel electrode, a layer of the data line, the layer being formed of the first material.

15. The method for manufacturing an active matrix substrate according to claim 14, wherein
the switching element includes a semiconductor layer,
the plurality of materials include a second material, and
the step of forming the gate line, the data line, and the pixel circuit includes a step of forming, together with the semiconductor layer, a layer of the data line, the layer being formed of the second material.
